(19) United States
(12) Patent Application Publication
(10) Pub. No.: US 2006/0157566 A1
(43) Pub. Date: Jul. 20, 2006

(54) Contactless card reader

(76) Inventors: Masahiro Kawasaki, HIROSHIMA (JP); Yasuhiro Shibata, Hiroshima-shi (JP); Shizuka Wada, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/547,179

(22) PCT Filed: Feb. 28, 2004
(86) PCT No.: PCT/JP04/19840

§ 371 Date: Aug. 29, 2005

(30) Foreign Application Priority Data
Jan. 14, 2004 (JP) 2004-007274

(51) Int. Cl. G06K 7/08

(52) U.S. Cl. 235/451

(57) ABSTRACT

The present invention provides a contactless card reader (300) that prevents information stored in a contactless card from being illegally utilized, without imposing too many loads on a holder of the contactless card. The contactless card reader includes: a flat antenna for communicating with the contactless card; an angle sensor (405) for detecting an angle of the antenna with respect to a horizontal plane; and a card reading unit (302) that executes processing of reading the information stored in the contactless card, and the card reading unit executes the reading processing only in the case where the angle detected by the angle sensor is within a predetermined range.

### TECHNICAL FIELD

The present invention relates to a contactless card reader for reading information stored in a contactless card.

### BACKGROUND ART

A basic mechanism for reading the information stored in a contactless card (hereinafter to be simply referred to as “card” as well) is as follows. The contactless card receives a request for transmitting the information by receiving slight electric waves from a contactless card reader (hereinafter to be simply referred to as “reader” as well) via an antenna that is embedded in the contactless card, and sends the stored information back to the reader. In this way, the reader can read the information stored in the card without contacting the card.

Such contactless card is already put into practice and is generally used as a train ticket, a pre-paid card, or the like.

The distance between the card and the reader at the time of reading can be extended by increasing the strength of electric waves and a degree of reception sensitivity. However, in the case of using the card as a season ticket for train, it is difficult to put this into practice since it is hard to know whether the detected card belongs to a person who is trying to pass or the following person. This is the reason why the distance between the card and the reader at the time of reading is limited approximately to 10 cm.

The reader can read the information stored in the card as long as it receives electric waves from the card, even in the case where there is something between them, e.g., a card is carried in a wallet or a bag.

The card readers are manufactured not only for public use as such that used for an automatic train ticket gate or a cash register, but also for personal use as such that is connectable to a personal computer or a Personal Digital Assistant (PDA). However, a contactless card reader intended for personal use and a portable one used for ticket examination in the train read the information only in the case where the distance between the card and the reader is about a few centimeters.

In the case where a contactless card reader 100 reads the information stored in a contactless card 101, as shown in FIG. 1A, the card 101 should be placed in a position parallel to the reader 100. In the case where the card 101 is placed in a position vertical to the reader 100, as shown in FIG. 1B, it is impossible for the reader 100 to read the information stored in the card 101 although they mutually contact. This is because a flat antenna 103 in the card 101 and a flat antenna 302a in the reader 100 are placed perpendicular to each other, so that the communication between the antennas is rendered difficult. This attributes to the reduction in the amount of consuming electricity, as well as to the limitation on output from the reader to a minimum requirement under the assumption that the card is placed above the reader in its actual use.

A wireless information transmission apparatus that exchanges information in name cards using a card is taken as an example of a portable reader. In the case where a card is carried in a metallic container, the transmission apparatus intercepts electric communication.

A “contactless medium and contactless medium system”, according to which a switch is set in the card so that a holder of the card can protect electric communication by using the switch, is disclosed.

### DISCLOSURE OF INVENTION

Many of the contactless cards are equipped with high security function against tampering of the information in the card since they serve as a medium dealing with electronic money. In some cases, however, the security function works less in the case of reading information with less confidentiality. For example, the information such as a balance of a pre-paid card can be read without any special process of authentication.

Availability of a PDA with functions of a contactless card reader for anyone renders it possible to easily read the information stored in the card in the case where the PDA is neared, to a certain distance, the card placed in a pocket or a bag.

For example, as shown in FIG. 2, it is assumed that an ill-intentioned person 211 who tries to read the personal information stored in the card 101 placed in the back pocket of an holder 201 of the card 101 who stands in a crowded train, by approaching from behind the holder 201. The ill-intentioned person 211 can read the personal information from the card 101 without being noticed, by bringing a PDA 212 with functions of a contactless card reader closer to the card 101 in the back pocket.

This is problematic since the personal information stored in the card 101 runs a risk of being intercepted by the ill-intentioned person 211.

In the case of overcoming such a problem by changing the structure of the contactless card, there rises a necessity to switch between readable and non-readable. The card holder therefore needs to take out the card out of the wallet or bag so as to change the setting of readable/non-readable. The holder may forget to switch the setting. Thus, restrictions related to convenience and security management are imposed on a victim whose personal information is robbed of, that is, the card holder.

The present invention is conceived in view of above problems, and an object of the present invention is to provide a contactless card reader that prevents the information stored in the contactless card from being illegally used, without imposing restrictions on the card holder.

In order to achieve the above object, a contactless card reader according to the present invention is a contactless card reader that reads information stored in a contactless card, and includes: a flat antenna for communicating with the contactless card; an angle detecting unit that detects an angle of the antenna with respect to a horizontal plane; and an executing unit that executes a predetermined operation, wherein the executing unit executes the predetermined operation only in the case where the angle detected by the detecting unit is within a predetermined range.

The predetermined operation may be a reading operation of reading, via the antenna, the information stored in the contactless card. In this case, the executing unit may execute the reading operation in the case where the angle is maintained for a predetermined period of time.

The contactless card reader according the present invention may further include a storing unit for storing information, wherein the predetermined operation may be a storing operation of storing, into the storing unit, the information stored in the contactless card, which is read out via the antenna. In this case, the executing unit may execute the storing operation in the case where the angle is maintained for a predetermined period of time.

The predetermined operation may be a displaying operation of displaying the information stored in the contactless card, which is read out via the antenna. In this case, the executing unit may execute the displaying operation in the case where the angle is maintained for a predetermined period of time.

The predetermined operation may be a card detecting operation of detecting the contactless card. In this case, the executing unit may execute the card detecting operation in the case where the angle is maintained for a predetermined period of time.

The predetermined range may be widened after the execution unit starts the execution of the predetermined operation.

The predetermined operation may be a warning operation. In this case, the executing unit may execute the warning operation in the case where the angle is maintained for a predetermined period of time.

The predetermined operation may be a record control operation of allowing the contactless card to record read information indicating that the information stored in the contactless card has been read out. In this case, the executing unit may execute the record control operation in the case where the angle is maintained for a predetermined period of time.

The contactless card reader according to the present invention may further include a storing unit for storing information, wherein the executing unit may not execute the predetermined operation in the case where an identifier of the contactless card is stored in the storing unit.

The contactless card reader according to the present invention may further include a display unit operable to display the angle detected by the angle detecting unit.

A contactless card for storing information according to the present invention is a contactless card for storing information and includes: a storing unit for storing information; an obtaining unit that obtains an angle of a flat antenna with respect to a horizontal plane, from a contactless card reader that reads the information stored in the storing unit, the antenna being embedded in the contactless card reader for communicating with the contactless card; and an output unit that outputs the information stored in the storing unit to the contactless card reader, only in the case where the angle obtained by the angle obtaining unit is within a predetermined range.

As described above, since the contactless card reader according to the present invention has such an angle detecting unit, it is possible to prevent the information stored in a contactless card from being used illegally without imposing too much loads on the card holder, by using the result obtained by the angle detecting unit. In other words, it is possible, by detecting the angle of the antenna with respect to the horizontal plane, to set restrictions related to the processing on information as described above such as reading.

In the case where the antenna is placed horizontal to the ground, the contactless card reader according to the present invention communicates with the contactless card, but does not communicate, otherwise. In this way, it is possible to prevent an illegal act of reading the information stored in the contactless card enacted by the ill-intentioned person. Furthermore, it is possible even to prevent the information that indicates presence/absence of the card from being obtained. In the case where the antenna is not placed horizontal, the contactless card reader according to the present invention does not communicate with the contactless card, therefore, power savings in the contactless card reader can be achieved as well.

The contactless card reader according to the present invention reads the information in the contactless card in the case where the antenna is posed horizontal to the ground, but does not otherwise. Accordingly, it is possible to prevent the illegal act of reading the information in the contactless card without being noticed by the card holder.

The contactless card reader according to the present invention recognizes the contactless card without reading since it can communicate with the contactless card. Based on this, the user can judge that it is possible to read the information stored in the contactless card by correctly setting the angle of the antenna within a predetermined range.

The contactless card reader according to the present invention stores the information read-out from the contactless card, in the case where the antenna is posed horizontal to the ground, but does not, otherwise. Thus, the read-out information can be protected from the secondary damage of being illegally distributed via the Internet or the like.

The contactless card reader according to the present invention also warns in the case where the angle of the antenna is not horizontal to the ground. Owing to this, in the case where the user cannot read the information stored in the contactless card because the antenna happens to be not horizontal even when the contactless card is not illegally used, the user can know the cause of it and read the information stored in the card by changing the angle of the contactless card reader.

The contactless card reader according to the present invention warns in the case where the antenna is not posed horizontal to the ground. In warning the user by means of beeps, the contactless card reader can explicitly inform of the user that the angle of the antenna is not properly posed. In the case where an ill-intentioned person attempts to illegally read the information in the contactless card of another person, the contactless card reader of the present invention informs the holder of the contactless card that the information in the card is being read or has been read from the card.

When reading the information in the contactless card in the case where the antenna is posed not horizontal to the ground, the contactless card reader according to the present invention leaves usage history indicating that the information in the card is read. Thus, it is possible to inform the card holder that the information in the card is illegally read. This discourages the ill-intentioned person from using the contactless card reader due to the fact that the usage history remains. The remaining of the usage history, however, does not pose any problems on the holder of the reader. Therefore, the contactless card reader is also effective because convenience is not degraded in the case of reading the information in the card when the antenna is not posed horizontal.

The contactless card reader according to the present invention informs the user of the angle of the antenna with respect to a horizontal plane, detected by the angle detecting unit. Thus, the user can judge whether it is due to the reading restricted by the angle of the antenna or an inability to recognize the contactless card that the information cannot be read. The contactless card reader presents to the user how he/she can read the information in the case where the restriction is imposed on reading by degree of angle. Thus, the user can manage to read the information.

The contactless card reader according to the present invention performs processing of reading and display only during the time when the angle of the antenna is maintained as previously predetermined or during the time when the contactless card reader can communicate with the contactless card. Thus, by changing the angle of the antenna embedded in the contactless card in the state where the contactless card is set ready by properly letting it recognized in the beginning of reading or replacing the card with another one so as to prevent illegal processing.

In the case where the contactless card reader according to the present invention cannot communicate with the contactless card because the angle of the antenna is changed from the initial state or because the card gets away from the card reader, the contactless card reader stops the processing of reading or display. Thus, the illegal use of the contactless card reader can be prevented.

The contactless card reader according to the present invention also extends the range for judging that the antenna of the card is horizontal as long as the communication with the card continues. Thus, in the case where the user operates the contactless card reader in the hand, it is possible to prevent interruption on the reading caused by the fact that the angle of the antenna is changed when the hand trembles during the reading operation.

As the antenna of the contactless card is frequently changed in the environment where the contactless card reader is subjected to the movement of the card holder such as in the train or during the walk, it is further possible to limit the usage of the contactless card reader by narrowing the range for judging that the antenna is placed horizontal.

In the case where the antenna is not placed horizontal, the contactless card reader according to the present invention performs the following processing: detecting an ID of the contactless card; judging that the contactless card is already registered based on the result of the detection; and reading the information in the card in the case where it is judged that the card is already registered. Thus, the contactless cards which are already registered are exempt from the reading limitation imposed by the detection of angles and the display of warning. Once the holder of the contactless card reader registers his/her contactless card, no limitations are imposed in the case where the antenna is not placed horizontal, and the convenience of the contactless card reader improves.

As is already described above, the present invention can provide the contactless card reader that prevents the information stored in the contactless card from being illegally used, without imposing loads on the card holders.

The present invention can be further realized as the method that includes the components, as steps, which are characteristic to the contactless card reader and the contactless card according to the invention, respectively. The invention can be also realized as a program that includes these steps, and as a storage medium such as a CD-ROM in which the program is stored, and even as an integrated circuit. The program can be distributed via a transmission medium such as a communication network.

### FURTHER INFORMATION ABOUT TECHNICAL BACKGROUND TO THIS APPLICATION

The disclosure of Japanese Patent Application No. 2004-007274 filed on Jan. 14, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIGS. 1A and 1B respectively show a positional relationship between a contactless card reader and a contactless card;

FIG. 2 shows a situation in which an ill-intentioned person attempts to illegally read the information in the contactless card that belongs to another person, using the contactless card reader;

FIG. 3A is an external view of the contactless card reader;

FIG. 3B is an illustration for describing the case where the contactless card reader reads the information stored in the contactless card;

FIG. 3C is an illustration for describing the case where the contactless card reader reads the information stored in the contactless card;

FIG. 4 is a diagram showing the hardware configuration of the contactless card reader according to a first embodiment;

FIG. 5 is an illustration showing two reference axes for detecting the angle of the antenna embedded in the contactless card reader;

FIG. 6 is a flowchart showing the processing of reading a contactless card according to the first embodiment;

FIG. 7A shows an angle of the antenna to be judged as horizontal based on an X-axis;

FIG. 7B shows an angle of the antenna to be judged as horizontal based on a Y-axis;

FIGS. 8A to 8C respectively show a relationship between the contactless card reader and the contactless card;

FIG. 9 is a flowchart showing the processing of reading a contactless card to which a step of displaying a warning is added;

FIG. 10 is a diagonal view of the cell phone 300a having the functions of the components in the contactless card reader 300;

FIG. 11 is a side view of the cell phone 300a shown in FIG. 10;

FIG. 12A illustrates the front surface of the cell phone 300a shown in FIG. 10;

FIG. 12B illustrates the back surface of the cell phone 300a shown in FIG. 10;

FIG. 13 is a diagonal view of the cell phone 300b having the functions of the components in the contactless card reader 300;

FIG. 14 is a flowchart showing the processing of reading a contactless card according to a second embodiment;

FIG. 15A is a display of the screen indicating that the contactless card reader stands by for reading;

FIG. 15B is a display of the screen indicating the information read-out from the contactless card;

FIG. 15C is a display of the screen indicating the direction to correct the angle by which the contactless card reader is posed;

FIG. 16 is a flowchart showing the processing of reading a contactless card according to a third embodiment;

FIG. 17A shows an angle of the antenna to be judged as horizontal based on the X-axis;

FIG. 17B shows an angle of the antenna to be judged as horizontal based on the Y-axis;

FIG. 18 is a flowchart showing the processing of reading a contactless card according to a fourth embodiment;

FIG. 19 is a flowchart showing the processing of reading the contactless card in the case where the card can be read although a warning is made;

FIG. 20 is a flowchart showing the processing of reading a contactless card according to a fifth embodiment;

FIG. 21 is a flowchart showing the processing of reading a contactless card according to a sixth embodiment;

FIG. 22 shows a situation in which the ill-intentioned person attempts to illegally read the information in the card that belongs to another person, using the contactless card reader;

FIG. 23 is a diagram showing the structure of the contactless card;

FIG. 24 is a diagram for describing the case of partly replacing, with an integrated circuit, the components that make up the contactless card reader; and

FIG. 25 is a diagram for describing the case of partly replacing, with an integrated circuit, the components that make up the contactless card.

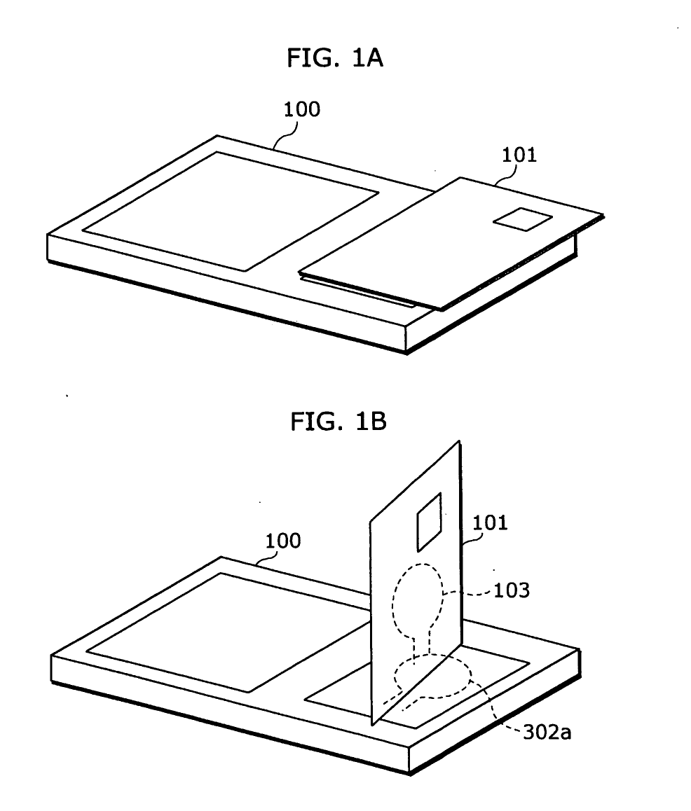

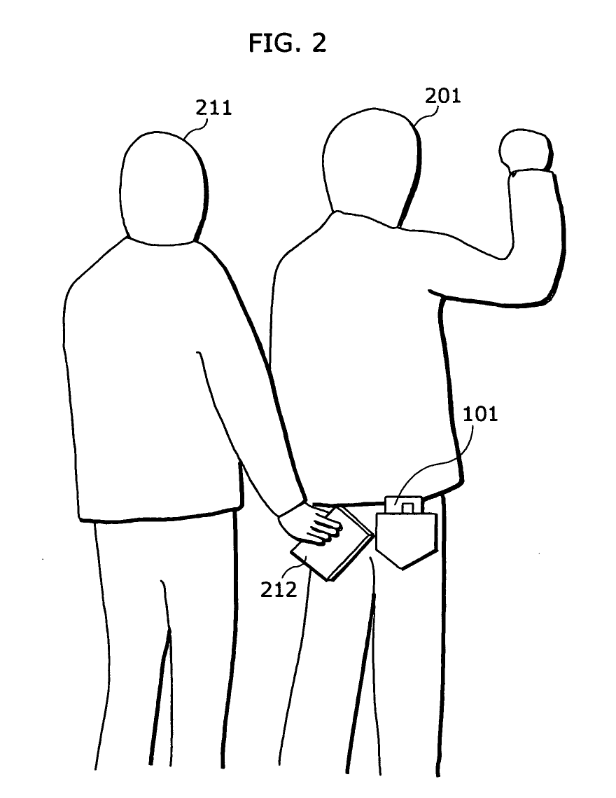

### BEST MODE FOR CARRYING OUT THE INVENTION

The following describes the best modes for implementing the present invention, with reference to the diagrams.

### First Embodiment

Firstly, the contactless card reader according to the first embodiment is described with reference to the diagram.

The holder of a contactless card usually carries the card in his/her pocket or bag. In the case of carrying the card in the pocket, of either a jacket or trousers, the card becomes parallel to the body. That is to say, the card becomes vertical to the ground. In the case of using a portable contactless card reader, the user operates the reader on the desk or in the hand, the card reader is horizontal or diagonal to the ground. In order to read the information stored in the card inserted in the card holder's pocket without being noticed, the reader has to be placed parallel to the contactless card, that is, vertical to the ground.

The present invention focuses on this point, and the reader reads the information in the card only in the case where the reader is placed horizontal to the ground, that is, in the case where the antenna embedded in the reader is horizontal. However, the reader does not read the information in the case where the reader is placed vertical to the ground. In this way, illegal reading of the information stored in the card is prevented.

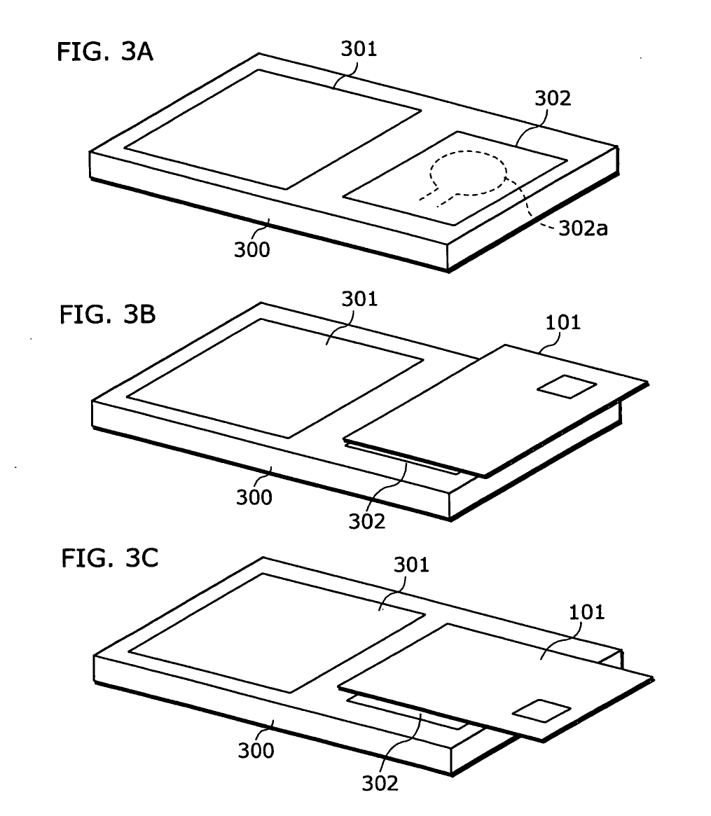

FIG. 3A is an external view of the contactless card reader 300 according to the first embodiment. The reader 300 includes: a card reading unit 302 in which an antenna 302a is embedded for reading the information stored in a contactless card 101; and a display unit (i.e. a display) 301 for displaying the read-out information. In the first embodiment, it is assumed that the antenna 302a and the display unit 301 are placed in parallel.

FIG. 3B is an illustration for describing the case where the reader 300 reads the information stored in the card 101. The reader 300 reads the information stored in the card 101 when the card 101 is placed over the card reading unit 302. In this case, the card 101 does not need to contact with the card reading unit 302. The card 101 may face any direction, as shown in FIG. 3C, as long as both of the card 101 and the reader 300 are placed horizontal.

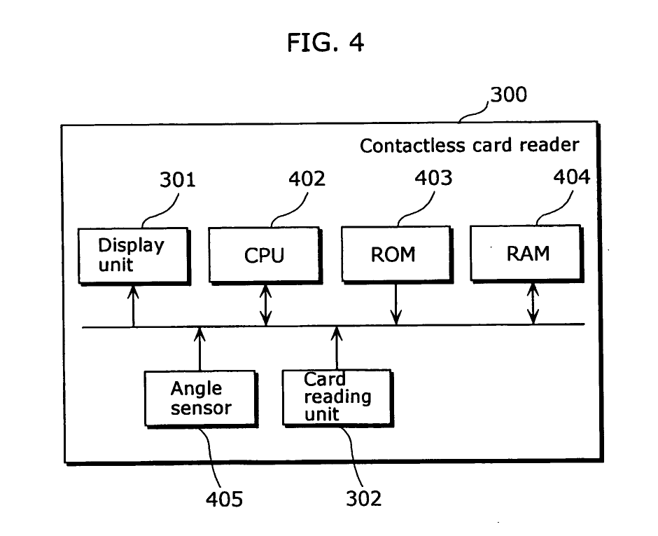

FIG. 4 shows the hardware configuration of the reader 300 according to the first embodiment. The reader 300 includes an angle sensor 405, in addition to the CPU 402, the ROM 403, the RAM 404, the display unit 301, and the card reading unit 302 which are included in the conventional contactless card reader.

Various kinds are available for the angle sensor 405. The angle sensor 405, for instance, is a sensor for detecting an angle between the antenna 302a embedded in the card reading unit 302 (see reference to FIG. 3A), and a horizontal plane, using a mercury switch. The angle sensor 405 may be a sensor that measures the angle to an earth axis (i.e. a direction of gravity) by examining the strength that is applied to the axis, using an acceleration sensor, and thus detects the angle of the antenna 302a. The range of measurement may be defined based on two axes of X and Y or three axes of X, Y and Z, instead of one. Namely, the angle sensor 405 detects an angle of the antenna 302a with respect to a horizontal plane. In other words, the angle sensor 405 detects the angle between the antenna 302a and the horizontal plane.

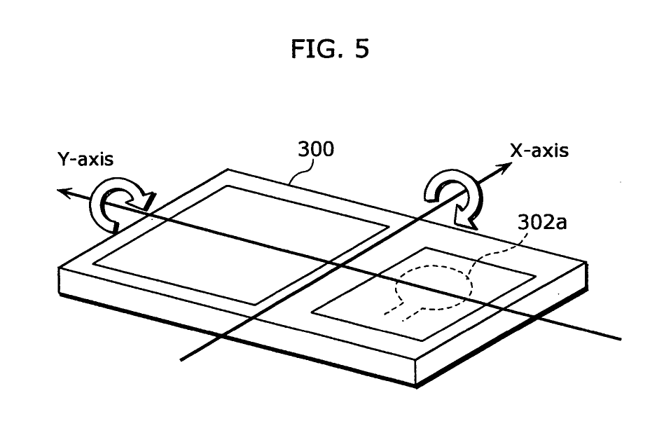

The first embodiment assumes the case where the angle sensor 405 detects the angle between the antenna 302a embedded in the reader 300 and the horizontal plane, within the range of 360 degrees based on the respective X and Y axes, as shown in FIG. 5. Note that the method of detecting an angle by the angle sensor 405 is not limited to the method mentioned above. Different method may be employed instead. The range of measurement is also not limited to the above case.

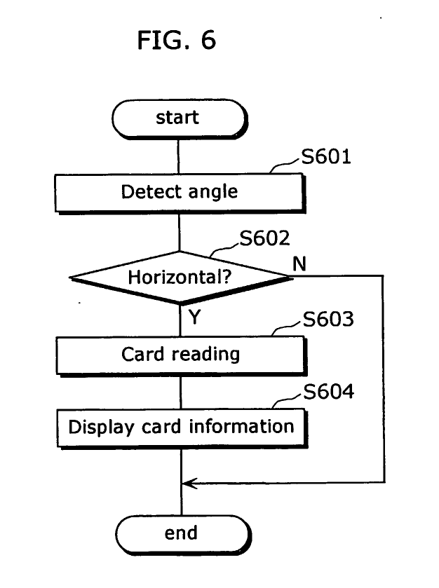

FIG. 6 is a flowchart showing the processing of card reading performed by the reader 300 according to the first embodiment. The “card reading” is to read the information stored in the card 101.

In the case where the reader 300 is turned on and the reader 300 stands by for card reading, a reading request is generated when the user brings the card 101 closer to the card reading unit 302. Namely, in the first embodiment, the reader 300 performs angle detection in the state where the reader 300 can communicate with the card 101.

When the reading request is generated, the angle sensor 405 in the reader 300 detects the angle between the antenna 302a and the horizontal plane (S601). The CPU 402 judges whether or not the angle detected by the angle sensor 405 is within the range defined for card reading based on both X and Y axes (S602). Namely, the CPU 402 judges whether or not the antenna 302a is horizontal (S602).

In the case of judging that the antenna 302a is horizontal (Y in S602), the CPU 402 allows the card reading unit 302 to execute card reading (S603), and allows the display unit 301 to display the information obtained through the card reading (S604). In the case of judging that the antenna 302a is not horizontal (N in S602), the CPU 402 does not allow the card reading unit 302 to execute card reading.

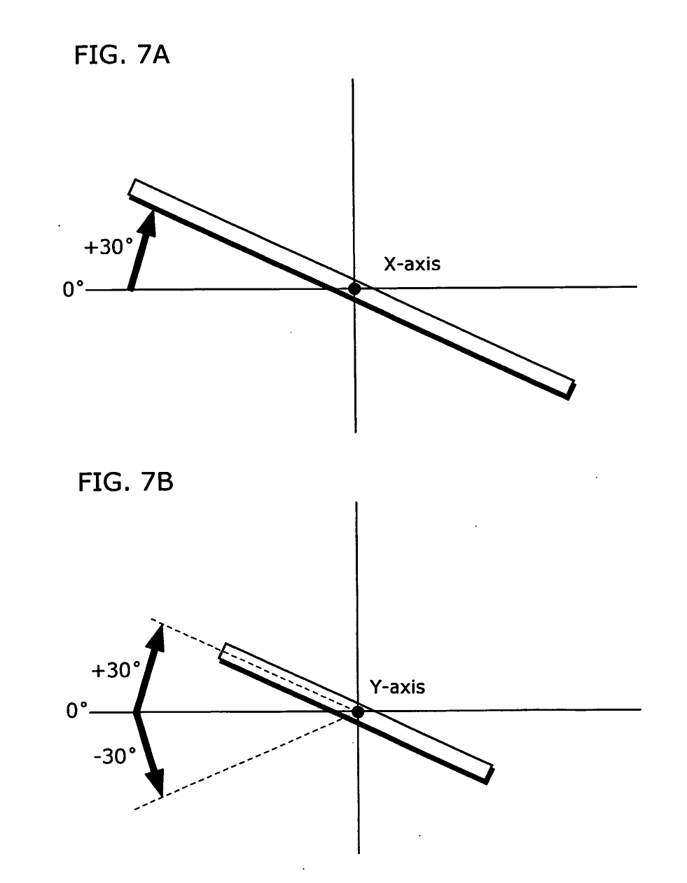

The CPU 402 judges whether or not the antenna 302a is horizontal as follows. The CPU 402 judges that the antenna 302a is horizontal in the case where the following conditions are satisfied when the display unit 301 is placed horizontal to the ground: the angle of the antenna 302a is within the range from 0 to +30 degrees based on the X-axis that is a reference axis for the case of slanting the reader 300 forward and backward, as shown in FIG. 7A; and the angle of the antenna 302a is within the range from −30 to +30 degrees based on the Y-axis that is a reference axis for the case of slanting the reader 300 in right and left directions, as shown in FIG. 7B.

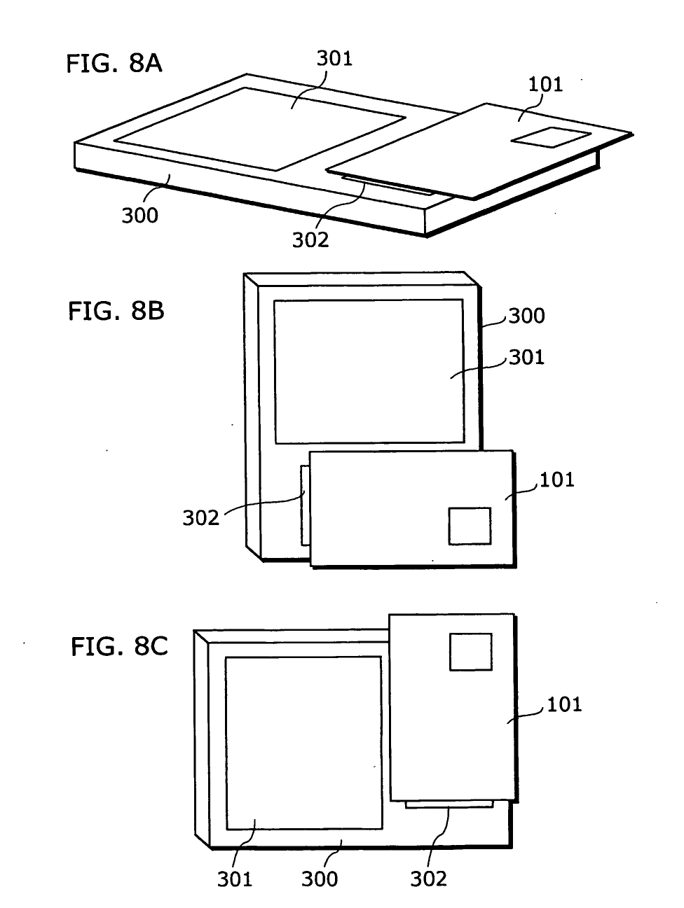

The lower limit in minus direction based on the X-axis is set to “0” with the view to eliminate the cases where the user cannot see the display unit 301. The angle sensor 405 detects the angle of the antenna 302a based on both X and Y axes. In this way, the CPU 402 allows the card reading unit 302 to execute card reading processing when judging that the antenna 302a is horizontal as shown in FIG. 8A. The CPU 402, however, does not allow the card reading unit 302 to execute the card reading processing when judging that the antenna 302a is not horizontal as shown in FIGS. 8B and 8C.

Note that the values used in the above are just examples, and appropriate values can be selected depending on the form and usage of the reader 300 as well as the accuracy in the operation performed by the angle sensor 405.

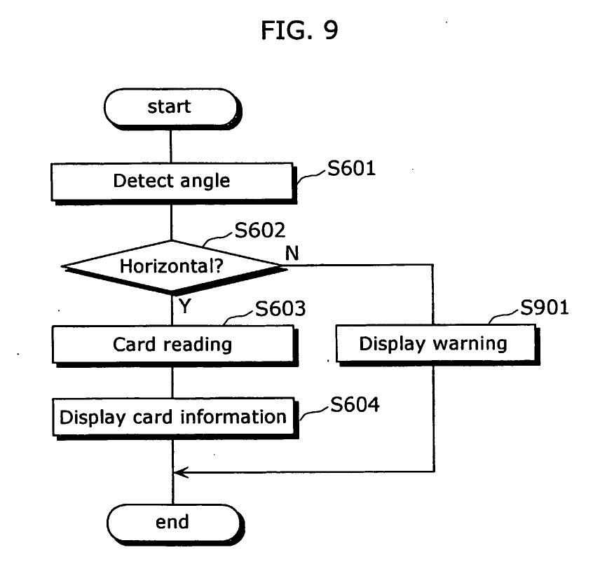

FIG. 9 is the operational flow described in FIG. 6 to which a warning display step (S901) is added. In the case of judging that the antenna 302a is not horizontal based on the information from the angle sensor 405, the CPU 402 allows the display unit 301 to display a warning message such as “Card reading cannot be operated since the reader is not set horizontal.” (S901).

The CPU 402 may allow the display unit 301 to display the card information read-out by the card reading unit 302, and also, record the information in the RAM 404 being a storage medium in the reader 300, so that the information can be put into secondary use. The CPU 402 may control in such way that the read-out information is displayed and recorded in the case where the angle detected by the angle sensor 405 is horizontal, but that the information is only displayed in the case where the angle is not horizontal. The CPU 402 may control so that the information is neither displayed nor recorded, in the case where the angle detected by the angle sensor 405 is not horizontal.

As described above, in the first embodiment, the card reading unit 302 does not read information stored in the card 101 in the case where the antenna 302a is not horizontal. In this way, it is possible to prevent the information stored in the card 101 that is placed in the pocket from being read without letting the card holder notice it.

By displaying the warning as shown in the warning display step (S901) in FIG. 9, in the case where card reading is not executed not because the reader is illegally used but because the antenna 302a happens to be not horizontal, the user can know the cause of it and let the card reading be executed by changing the angle of the reader 300.

In the case where the antenna 302a is horizontal, the information read out in the card reading processing can be recorded, and in the case where the antenna 302a is not horizontal, the information are not stored. Thus, it is possible to prevent the secondary damage such that the read-out information is illegally distributed via the Internet or the like.

Note that a warning is displayed in the warning display step (S901) in FIG. 9, however, the CPU 402 may output a warning by beeps.

The embodiment described above has described the contactless card reader 300 in which the antenna 302a and the display unit 301 are placed in parallel, as shown in FIG. 3A.

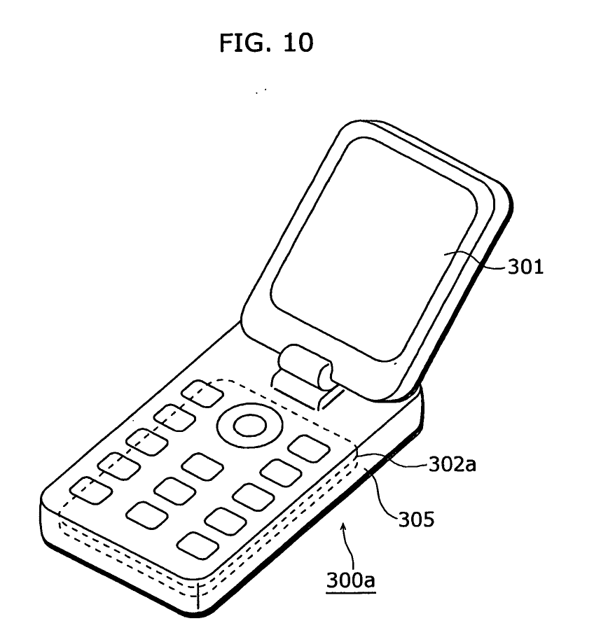

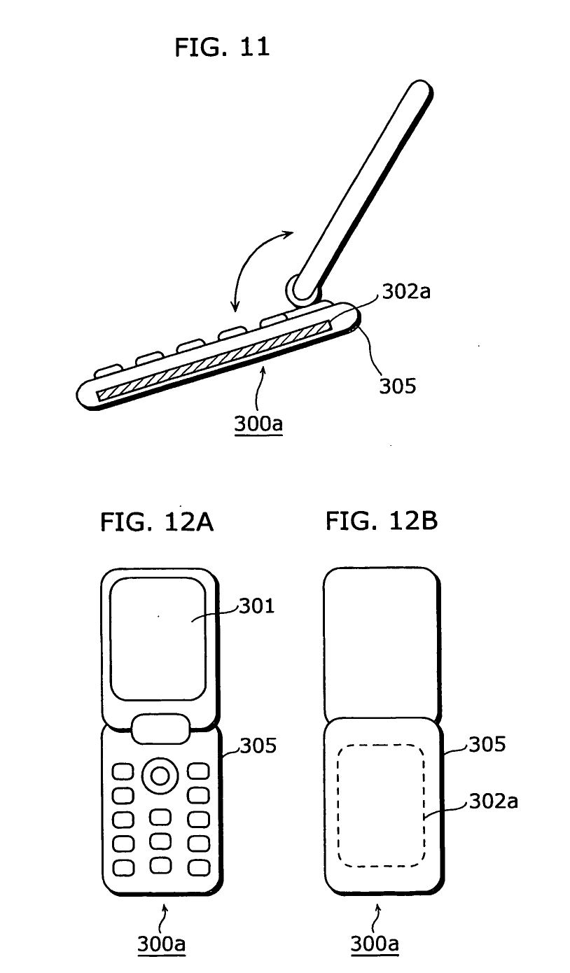

However, as shown in FIGS. 10 to 12, the contactless card reader may be realized with a cell phone 300a having the functions of the components in the reader 300. FIG. 10 is a diagonal view of the cell phone 300a with the display unit 301 that is flipped open. FIG. 11 is a side view of the cell phone 300a shown in FIG. 10. FIG. 12A illustrates a front surface of the cell phone 300a while FIG. 12B illustrates a back surface of it.

As in the cell phone 300a with the state in which the display unit 301 is flipped open, as shown in FIGS. 10 to 12, the antenna 302a is not in parallel to the display unit 301. In the case of using such cell phone 300a, the CPU 402 judges whether or not the antenna 302a is horizontal based on the angle detected by the angle sensor 405, as in the case of the embodiment described above. The operation of the cell phone 300a based on the result of the judgment is as same as that of the reader 300 described above.

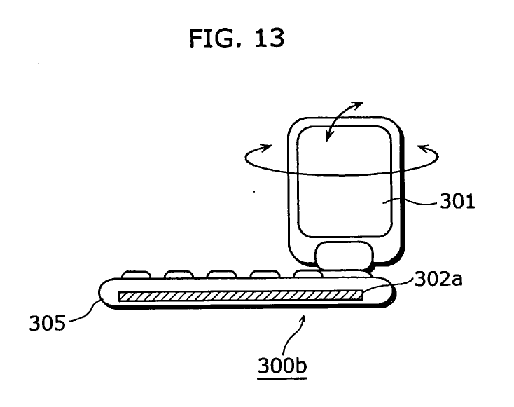

As shown in FIG. 13, the contactless card reader may be realized with a flip phone 300b having the functions of the components in the reader 300. The display unit 301 in the cell phone 300b can be unfolded and then can partially rotate. The CPU 402 in the flip phone 300b, as in the case of above embodiment, judges whether or not the antenna 302a is horizontal based on the angle detected by the angle sensor 405. The operation of the flip phone 300b based on the result of judgment is as same as that of the reader 300 as described above.

Namely, the CPU 402 in the contactless card reader judges whether or not the antenna 302a is horizontal based on the angle detected by the angle sensor 405.

The following describes, in order to simplify the description, a different embodiment of the contactless card reader according to the present invention, by taking an example of the contactless card reader 300 in which the antenna 302a and the display unit 301 are placed in parallel as shown in FIG. 3A.

### Second Embodiment

Next, the contactless card reader according to the second embodiment will be described with reference to the diagrams.

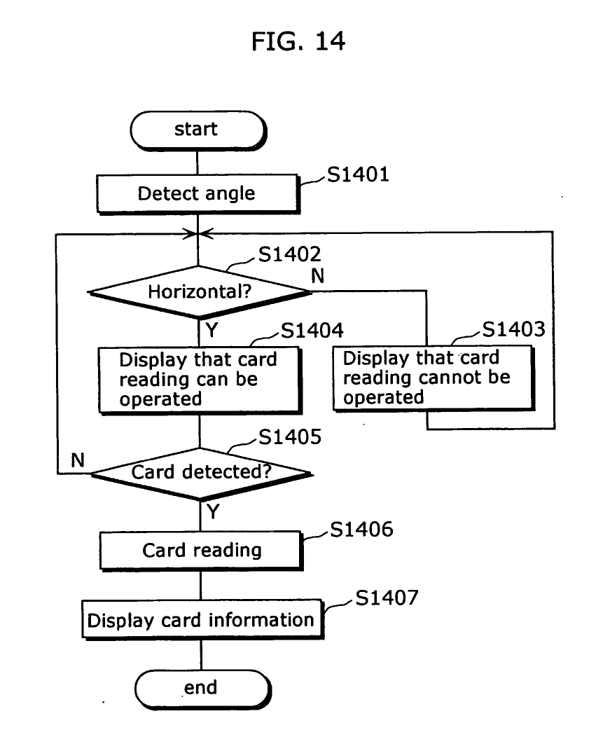

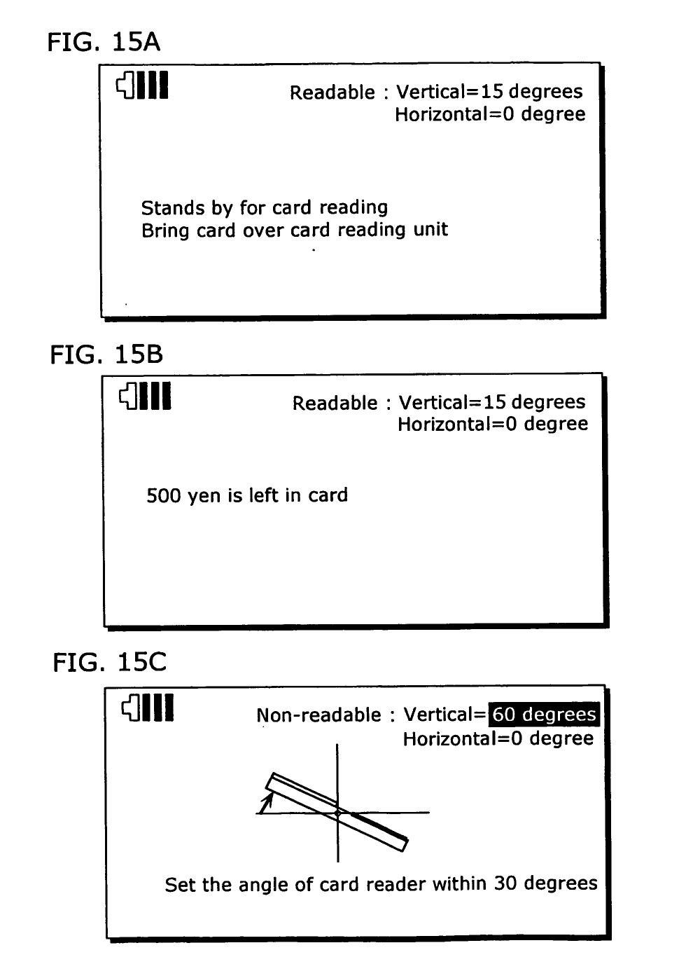

FIG. 14 is a flowchart showing the processing of card reading to which a processing of indicating whether or not the information in the card is readable is added. When the reader 300 is turned on and stands by for card reading, the display unit 301 displays a message for requesting the user to bring the card 101 over the reader 300 as shown in FIG. 15A. The angle sensor 405 detects the angle between the antenna 302a and the horizontal plane (S1401). The CPU 402 judges whether or not the angle detected by the angle sensor 405 is within the range defined for card reading based on both X and Y axes (S1402). Namely, the CPU 402 judges whether or not the antenna 302a is horizontal (S1402).

When judging that the antenna 302a is not horizontal (N in S1402), the CPU 402 allows the display unit 301 to display the information indicating that card reading cannot be performed (S1403). Then, the CPU 402 returns back to the step (S1402) of judging whether or not the antenna 302a is horizontal.

When judging that the antenna 302a is horizontal (Y in S1402), the CPU 402 allows the display unit 301 to display the information indicating that card reading can be performed (S1404). The CPU 402 then allows the card reading unit 302 to execute the processing for detecting the card (S1405). In the case where the card is detected (Y in S1405), the CPU 402 allows the card reading unit 302 to execute card reading (S1406), and allows the display unit 301 to display the information obtained through card reading, as shown in FIG. 15B (S1407). In the case where the card is not detected (N in S1405), the CPU 402 returns back to the step (S1402) of judging whether or not the antenna 302a is horizontal.

The CPU 402 may allow the display unit 301 to display not only whether or not reading can be performed based on the angle of the antenna 302a, but also the angle detected by the angle sensor 405 as shown in FIG. 15A. In the case where reading cannot be performed, the CPU 402 allows the display unit 301 to display information such as the amount of degrees by which the contactless card 101 needs to be put back so that the antenna 302a is judged as horizontal based on which reading can be performed as shown in FIG. 15C, and presents it to the user.

In the second embodiment, the reader 300 does not communicate with the card 101 in the case where the angle of the antenna 302a is not horizontal.

As described above, in the second embodiment, the CPU 402 does not let the information stored in the card 101 be read out, in the case where the antenna 302a is not horizontal. Thus, it is possible to prevent the information stored in the card 101 which is placed in the pocket from being read without letting the card holder notice it. In addition, the CPU 402 does not allow the reader 300 to communicate with the card 101, in the case where the antenna 302a is not horizontal. It is therefore also possible to prevent the information that indicates presence/absence of the card 101 from being obtained. Since no communications are performed between the reader 300 and the card 101, power savings can be realized in the reader 300.

The angle detected by the angle sensor 405 is displayed, so that the user can know whether it is due to the limitations on reading imposed based on angle or due to the state in which the reader 300 cannot detect the card 101, that the information stored in the card 101 cannot be read. In the case the failure to read the information attributes to the former case, the user can handle the problem so as to read the information in the card 101, since the solution for reading the information is presented to the user.

### Third Embodiment

The following describes the contactless card reader according is to the third embodiment with reference to the diagrams.

In some cases, after the judgment that the antenna 302a is horizontal and card reading is started, the angle between the antenna 302a and the horizontal plane changes during the operation for the card reading. The flowcharts shown in FIGS. 6 and 9 do not assume the case in which the angle of the antenna changes after the card reading is started. It is, however, assumable that the angle between the antenna 302a and a horizontal plane may change so that the antenna 302a is no longer horizontal. In such case, the contactless card reader 300 stops reading the contactless card 101 as is the case where the card 101 gets away from the reader 300.

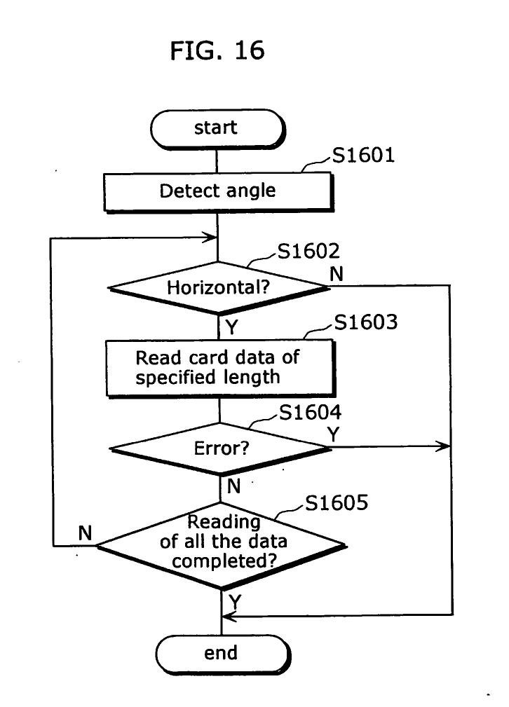

FIG. 16 is a flowchart showing the card reading processing that also includes the processing in the case where the antenna 302a is no longer horizontal due to the change of the angle between the antenna 302a and the horizontal plane.

When card reading is requested, the angle sensor 405 in the reader 300 detects the angle between the antenna 302a and the horizontal plane (S1601). The CPU 402 judges whether or not the angle detected by the angle sensor 405 is within the range defined for card reading based on both X and Y axes (S1602). In other words, the CPU 402 judges whether or not the antenna 302a is horizontal (S1602).

When judging that the antenna 302a is not horizontal (N in S1602), the CPU 402 does not allow the card reading unit 302 to execute card reading.

When judging that the antenna 302a is horizontal (Y in S1602), the CPU 402 allows the card reading unit 302 to execute card reading for the information equivalent to the amount of bytes that is specified (S1603).

In this case, the CPU 402 make the card reading unit 302 to stop the card reading in the case where reading error has occurred (Y in S1604) such that the card 101 is too distant for the electric waves from the reader 300 to reach. In the case where such error does not occur (N in S 1604), the CPU 402 judges whether or not the processing of reading all the information stored in the card 101 is completed (S1605). When judging that the reading of the entire information is not completed (N in S1605), the CPU 402 returns to the step (S1602) of judging whether or not the antenna 302a is horizontal. When the CPU 402 judges that the reading of the entire information is completed (Y in S1605), the reader 300 terminates the operation.

Similarly, the CPU 402 controls so that the read-out information is displayed as long as the antenna 302a remains horizontal, and the display disappears at the point when the antenna 302a is no longer horizontal. In the case where the antenna 302a becomes horizontal again, the CPU 402 does not display again the information that is previously-read, but the information that is newly read from the card 101.

In the case where it turns out that the electric waves from a different contactless card comes in during the communication with the contactless card in operation, the CPU 402 processes it considering that the communication is interrupted.

Note that the CPU 402 allows card reading to be executed when the antenna 302a is horizontal. When the antenna 302a is, however, no longer horizontal, the CPU 402 may not only erase the displayed information, but also execute card reading when the antenna 302a is not horizontal, and let the displayed information disappear when the antenna 302a becomes horizontal again.

In the case where the reader is used in the hand, the angle between the antenna 302a and the horizontal plane is not maintained during the operation due to the movement of the hand or the person holding the reader 300. The reader 300 may be set so that the operation of card reading continues once reading is allowed, as long as the reader 300 continues the communication with the card 101, even when the angle of the antenna 302a gets larger.

To be more precise, the judgment on whether or not the antenna 302a is horizontal is as already described with reference to FIGS. 7A and 7B. The antenna 302a is judged to be horizontal in the case where the following conditions are fulfilled: the angle to the horizontal plane is within the range from 0 to +30 degrees based on the X-axis (see reference to FIG. 7A) and within the range from −30 to +30 degrees based on the Y-axis (see reference to FIG. 7B).

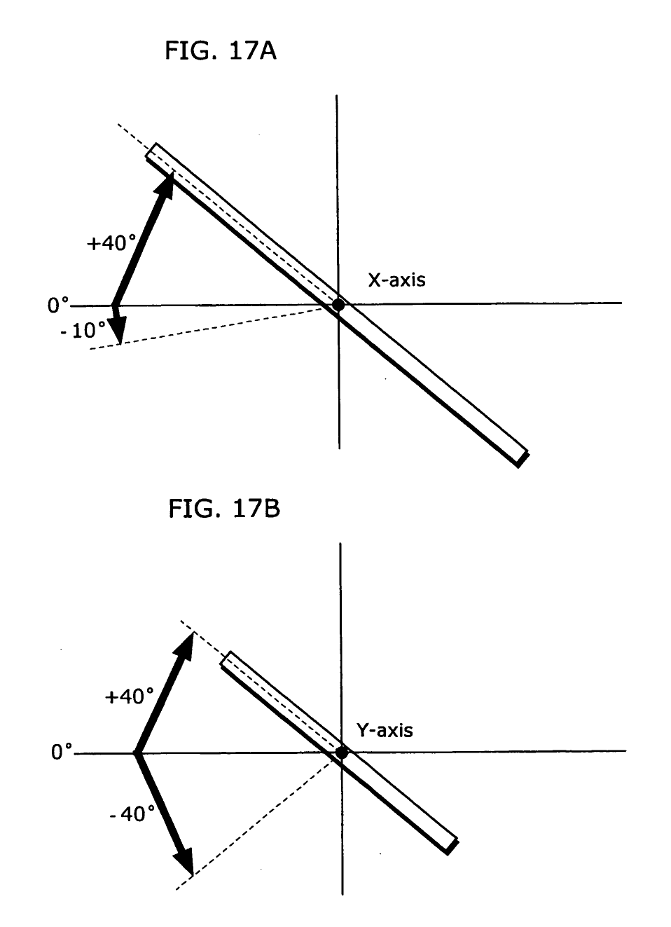

The antenna 302a may be judged to be horizontal, however, as long as the reader 300 continues the communication with the card 101 and in the case where the following conditions are met: the angle to the horizontal plane is within the range from −10 to +40 based on the X-axis as shown in FIG. 17A, and is within the range from −40 to +40 based on the Y-axis as shown in FIG. 17B. Namely, so far as the communication is kept between the reader 300 and the card 101, the antenna 302a may be judged to be horizontal even when the angle between the antenna 302a and the horizontal plane gets larger by 10 degrees to the plus side and minus side, respectively. Note that in the case where the communication with the card 101 is interrupted, the initial criteria for judging whether or not the antenna 302a is horizontal, which are shown in FIGS. 7A and 7B, are used again.

As described above, the reader 300 according to the third embodiment examines the angle between the antenna and the horizontal plane even during the card reading processing. This can prevent the ill-intentioned person from illegally reading the information stored in the card 101 that is placed in someone's pocket, by rendering the reader 300 (i.e. antenna 302a) horizontal for just a moment at the beginning of the card reading, and then, vertical, so that the information in the card is read without being noticed by the card holder.

The reader 300 lets the displayed information disappear even in the state where the read-out information is displayed on the screen after the completion of the card reading, in the case where the angle of the antenna 302a changes from the previously determined angle, or in the case where the reader 300 can no longer communicate with the card 101 since the card 101 is moved from the reader 300, for example. Thus, the ill-intentioned person has to take an unnatural position in order to see the information after having illegally read the personal information in the card 101. This makes it difficult for the ill-intentioned person to see the information that has been displayed. As a result, unauthorized use of the reader 300 can be prevented.

Normally, it is rare that the angle between the antenna 302a and the horizontal plane greatly changes or that the reader 300 fails to communicate with the card 101. The user therefore seldom feels certain inconvenience in using the reader 300 having the angle sensor 405.

The range for determining that the antenna 302a is horizontal gets wider while the communication between the reader 300 and the card 101 continues. This prevents the card reading from being interrupted if the amount of change is small, even in the case where the reader 300 is operated in the hand and the angle between the antenna 302a and the horizontal plane changes due to the fact that the initial state of the reader 300 cannot be maintained since the hand moves from the initial position, for instance, during the card reading operation.

In contrast, when the range for judgment on whether or not the antenna 302a is horizontal is narrowed, the angle of the antenna 302a gets off easily from the defined range, in the case of using the reader 300 in the state where the movement is larger such that the reader 300 is operated in the train or during a walk. The limitations can be therefore imposed on the usage of the reader 300.

### Fourth Embodiment

The following describes the contactless card reader according to the fourth embodiment with reference to the diagrams.

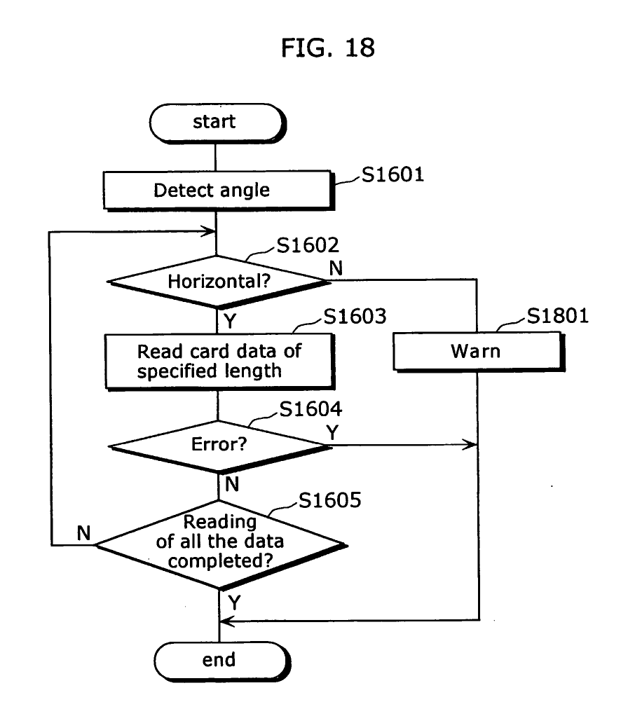

FIG. 18 is a flowchart showing the card reading processing described in the third embodiment, to which a process of warning in the case where the antenna 302a is not horizontal is added.

When judging that the antenna 302a is not horizontal (N in S1602), the CPU 402 warns the user of it (S1801). The warning is made by beeps, e.g., beeping or a voice message “Card reading cannot be operated.” is outputted.

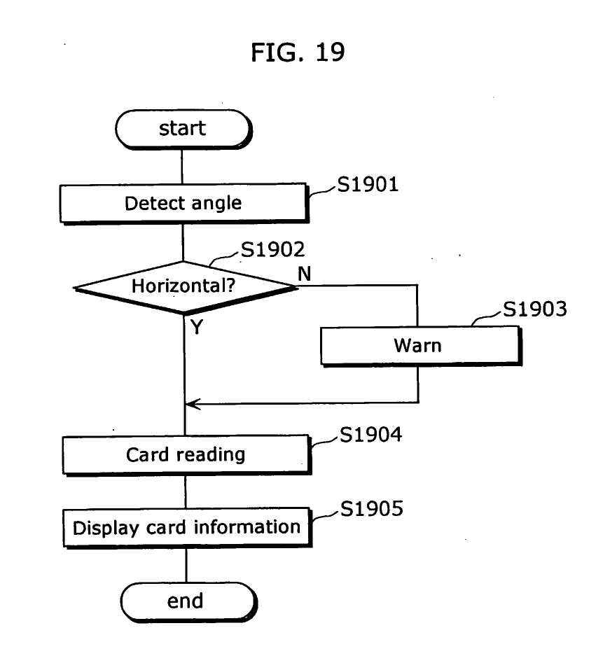

FIG. 19 is a flowchart showing the card reading in the case where a warning is made but card reading can be operated.

When a reading request is made, the angle sensor 405 in the contactless card reader 300 detects the angle between the antenna 302a and the horizontal plane (S1901). The CPU 402 judges whether or not the angle detected by the angle sensor 405 is within the range defined for card reading based on both X and Y axes (S1902). Namely, the CPU 402 judges whether or not the antenna 302a is horizontal (S1902).

When judging that the antenna 302a is not horizontal (N in S1902), the CPU 402 warns it by beeps (S1903).

After that, the CPU 402 allows the card reading unit 302 to execute card reading regardless of whether or not the antenna 302a is horizontal (S1904), and lets the display unit 301 display the information obtained through the card reading (S1905).

As described above, the reader 300 according to the fourth embodiment expressively informs the user, by warning using beeps, that the antenna 302a is not horizontal. In other words, the user is informed that the angle of the reader 300 is not correct. In the case where the information stored in the card 101 is under the risk of being illegally read without the card holder's notice, it is thus possible to inform the holder that the information in the card 101 is being read or has been read.

### Fifth Embodiment

The following describes the contactless card reader according to the firth embodiment with reference to the diagrams.

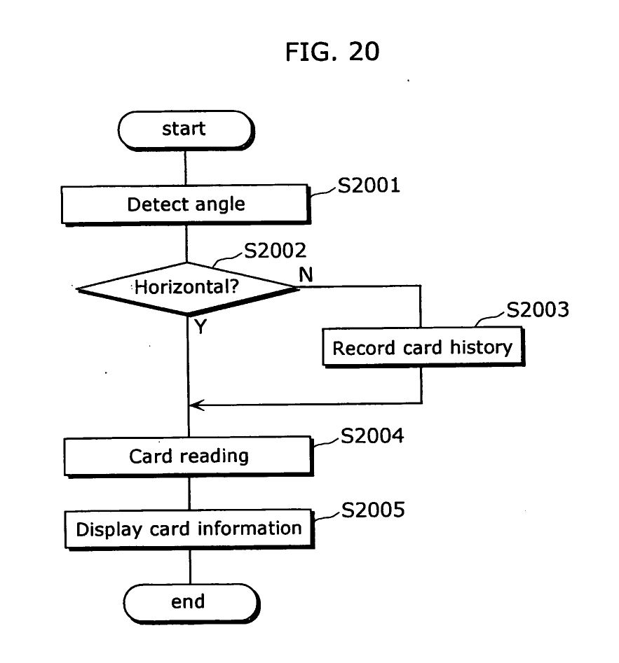

FIG. 20 is a flowchart showing the case of recording a usage history into the contactless card 101 when card reading is executed although the antenna 302a is not horizontal.

When a reading request is made, the angle sensor 405 in the contactless card reader 300 detects the angle between the antenna 302a and the horizontal plane (S2001). The CPU 402 judges whether or not the angle detected by the angle sensor 405 is within the range defined for card reading based on X and Y axes (S2002). That is to say that the CPU 420 judges whether or not the antenna 302a is horizontal (S2002).

When judging that the antenna 302a is not horizontal (N in S2002), the CPU 402 lets the card 101 record a history indicating that the card 101 is used (S2003).

After that, the CPU 402 allows the card reading unit 302 to execute card reading irrespective of whether or not the antenna 302a is horizontal (S2004), and lets the display unit 301 display the information obtained through the card reading (S2005).

The record of the history may include not only the record of an event that card reading is performed, but also the records such as date and time when card reading is executed, an identification number such as a manufacturer's number of the reader 300, or a name of the user of the reader 300.

In the example shown in FIG. 20, a history is written in the card 101 before the execution of card reading. This is because, in some cases, a history may not be recorded although card reading is performed, in the case where the reader 300 no longer communicates with the card 101 during the card reading when the history is written after the completion of the card reading. This can be handled by controlling the read-out information to be invalid until the history is written after the execution of the card reading so that the information cannot be displayed on the screen or stored into the storage medium.

As described above, in the fifth embodiment, in the case where the reader 300 attempts to read the information stored in the card 101 in a state where the antenna 302a is not horizontal, it is possible to inform the holder of the card 101 that the information in the card 101 is illegally read, by leaving the usage history in the card 101.

The person who attempts to read the information in the card 101 becomes reluctant to enact an illegal card reading since the trace remains in the card 101. It does not matter, however, that the history of using for one's own purpose remains in the card of one's own. Card reading can be therefore executed even in the state where the antenna 302a is not horizontal, and it is thus effective in that the convenience in using the reader 300 is not degraded.

### Sixth Embodiment

The following describes the contactless card reader according to the sixth embodiment.

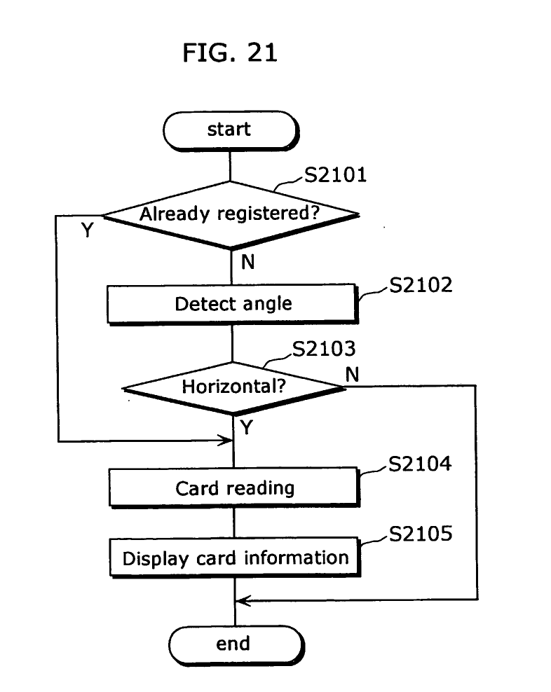

FIG. 21 is a flowchart for executing card reading processing based on the judgment on whether or not an identifier of the contactless card is registered.

When a reading request is made, the CPU 402 in the contactless card reader 300 reads a unique ID of the contactless card 101 and judges whether or not the read-out ID is already registered in the RAM 404 (S2101).

When judging that the ID is registered (Y in S2101), the CPU 402 allows the card reading unit 302 to execute card reading regardless of whether or not the antenna 302a is horizontal (S2104), and lets the display unit 301 display the information obtained through the card reading (S2105).

When the CPU 402 judges that the ID is not registered (N in S2101), the angle sensor 405 detects the angle between the antenna 302a and the horizontal plane (S2102). The CPU 402 judges whether or not the angle detected by the angle sensor 405 is within the range defined for card reading based on both X and Y axes (S2103). That is to say that the CPU 402 judges whether or not the antenna 302a is horizontal (S2103).

When judging that the antenna 302a is not horizontal (N in S2103), the CPU 402 does not allow the card reading unit 302 to execute card reading.

When judging that the antenna 302a is horizontal (Y in S2103), the CPU 402 allows the card reading unit 302 to execute card reading (S2104), and lets the display unit 301 display the information obtained through the card reading (S2105).

The registration of the unique ID (i.e. identifier) of the card 101 is carried out when the CPU 402 could properly read the information stored in the card 101 in the state where the antenna 302a is horizontal, by recording, into the RAM 404, the ID uniquely assigned to the card 101. The CPU 402 may register all the unregistered identifiers of the card 101 in which the read-out information is stored, or inquire the user whether to register the ID or not, and then, register in the case where the user instructs for registration.

For the card 101 whose ID is not yet registered, besides mere prohibition against card reading, the warning message as described in the previous embodiment may be displayed, the warning may be made by beeps while card reading is permitted, or a usage history may be recorded into the card 101.

As described above, in the sixth embodiment, for the card 101 whose identifier is registered is exempt from the reading restriction based on the angle detection as well as the display of warning. Thus, by registering the identifier of the card 101, there will be no limitation imposed in the case where the angle is not horizontal from the second time, so that the convenience is further improved.

Note that the ID (i.e. identifier) uniquely assigned to the card 101 may be stored into a non-volatile memory area in the contactless card reader 300.

The CPU 402 may not allow the card reading unit 302 to execute card reading in the case where the angle is not maintained for a predetermined period of time, e.g., one minute, even when the antenna 302a is horizontal, that is, when the angle between the antenna 302a and the horizontal plane is within the predetermined range.

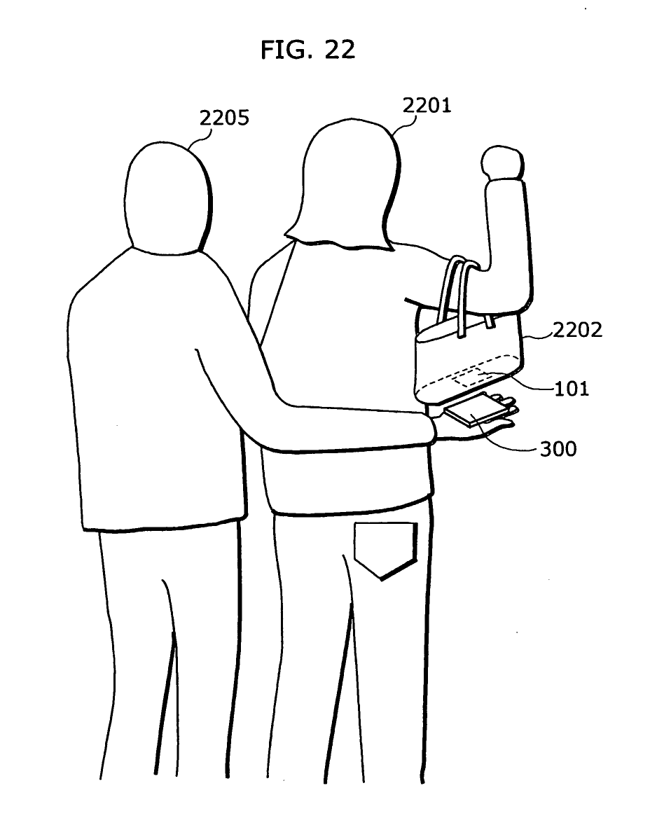

For example, in the case where the card 101 is placed in a shoulder bag 2202 of a lady 2201 who stands in the train, as shown in FIG. 22, the card 101 in the bag 2202 moves as the train moves. In some cases, however, the angle of the card 101 is maintained to be judged as horizontal. In this case, the ill-intentioned person 2205, who stands behind the lady 2201 and holds the reader 300 described in the above embodiment, can get the information stored in the card 101 by horizontally approaching, to the card 101, the antenna 302a, namely, the reader 300.

This can be prevented, however, by the CPU 402 that controls the card reading unit 302 not to execute card reading in the case where the antenna 302a is horizontal with respect to the horizontal plane, but is not maintained at the same angle for a predetermined period of time, e.g., one minute.

Similarly, the CPU 402 may control the display unit 301 not to display the read-out information although card reading is permitted, in the case where the angle between the antenna 302a and the horizontal plane is horizontal, but is not maintained, for instance, for one minute. In such case, the CPU 402 may control in such way that the read-out information is not stored, card detection is not executed, a warning is made, or a history is recorded in the card 101.

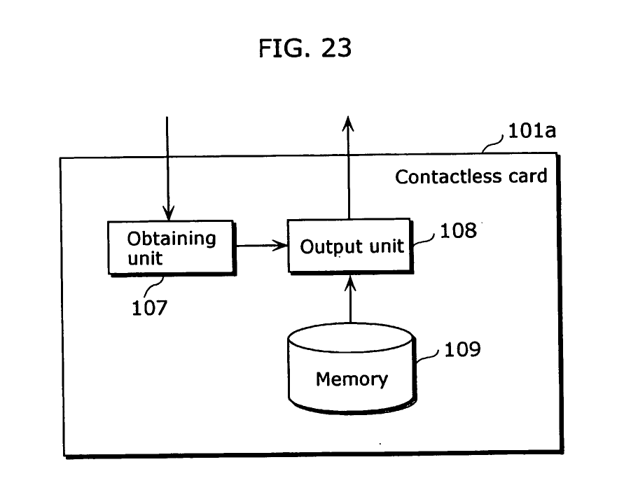

Moreover, as described in the above, in the case where the angle of the antenna 302a is out of the predetermined range, the reader 300 may control the use of the stored information so that the information stored in the card 101 is not read, for example. However, the control, as shown below, may be carried out by the card 101. That is to say that an obtainment unit 107 in the contactless card 101a obtains the angle between the antenna 302a and the horizontal plane from the reader 300, as shown in FIG. 23, and an output unit 108 transmits the information stored in a memory 109 to the reader 300, only in the case where the obtained angle is within the predetermined range. In this case, it is possible to prevent the information stored in the card 101a that is carried in the pocket from being read without the holder's notice.

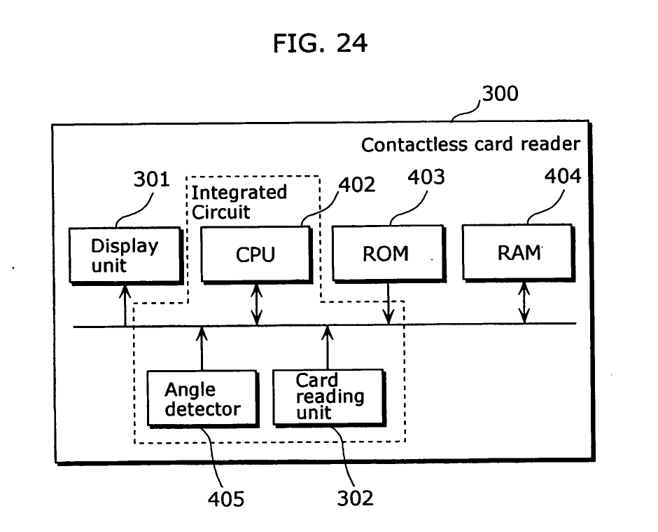

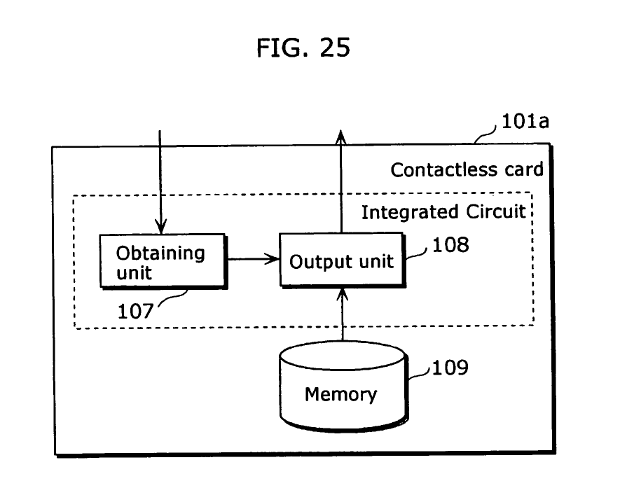

It should be noted that the components in the contactless card reader 300 which are surrounded by a dashed line as shown in FIG. 24, namely, the card reading unit 302, the CPU 402, and the angle sensor 405, may be realized by an integrated circuit. Similarly, the components in the contactless card 101a which are surrounded by a dashed line as shown in FIG. 25, that is, the obtaining unit 107 and the output unit 108, may be realized also by an integrated circuit.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The contactless card reader according to the present invention is useful for preventing illegal acts of reading the contactless card held by another person without his/her permission.

1. A contactless card reader that reads information stored in a contactless card, comprising:
a flat antenna for communicating with the contactless card;
an angle detecting unit operable to detect an angle of the antenna with respect to a horizontal plane; and
an executing unit operable to execute a predetermined operation,
wherein the executing unit executes the predetermined operation only in the case where the angle detected by the detecting unit is within a predetermined range.

2. A contactless card reader according to claim 1,
wherein the predetermined operation is reading, via the antenna, the information stored in the contactless card.

3. A contactless card reader according to claim 2,
wherein the executing unit executes the reading operation in the case where the angle is maintained for a predetermined period of time.

4. A contactless card reader according to claim 1, further comprising
a storing unit for storing information,
wherein the predetermined operation is storing, into the storing unit, the information stored in the contactless card, which is read out via the antenna.

5. A contactless card reader according to claim 4,
wherein the executing unit executes the storing operation in the case where the angle is maintained for a predetermined period of time.

6. A contactless card reader according to claim 1,
wherein the predetermined operation is displaying the information stored in the contactless card, which is read out via the antenna.

7. A contactless card reader according to claim 6,
wherein the executing unit executes the displaying operation in the case where the angle is maintained for a predetermined period of time.

8. A contactless card reader according to claim 1,
wherein the predetermined operation is detecting the contactless card.

9. A contactless card reader according to claim 8,
wherein the executing unit executes the card detecting operation in the case where the angle is maintained for a predetermined period of time.

10. A contactless card reader according to claim 1,
wherein the predetermined range is widened after the execution unit starts the execution of the predetermined operation.

11. A contactless card reader according to claim 1,
wherein the predetermined operation is warning.

12. A contactless card reader according to claim 11,
wherein the executing unit executes the warning operation in the case where the angle is maintained for a predetermined period of time.

13. A contactless card reader according to claim 1,
wherein the predetermined operation is controlling the contactless card to record read information indicating that the information in the contactless card has been read out.

14. A contactless card reader according to claim 13,
wherein the executing unit executes the controlling operation in the case where the angle is maintained for a predetermined period of time.

15. A contactless card reader according to claim 1, further comprising
a storing unit for storing information,
wherein the executing unit does not execute the predetermined operation in the case where an identifier of the contactless card is stored in the storing unit.

16. A contactless card reader according to claim 1, further comprising
a display unit operable to display the angle detected by the angle detecting unit.

17. A contactless card for storing information, comprising:
a storing unit for storing information;
an obtaining unit operable to obtain an angle of a flat antenna with respect to a horizontal plane, from a contactless card reader that reads the information stored in the storing unit, the antenna being embedded in the contactless card reader for communicating with the contactless card; and
an output unit operable to output the information stored in the storing unit to the contactless card reader, only in the case where the angle obtained by the angle obtaining unit is within a predetermined range.

18. An information processing execution method for executing processing on information stored in a contactless card, comprising:
detecting an angle of a flat antenna with respect to a horizontal plane, the antenna being for communicating with the contactless card; and
executing a predetermined operation,
in the executing, the predetermined operation is executed only in the case where the angle detected in the detecting is within a predetermined range.

19. An output method for outputting information stored in a contactless card, comprising:
obtaining an angle of a flat antenna with respect to a horizontal plane, from a contactless card reader that reads the information stored in the contactless card, the antenna being embedded in the contactless card reader for communicating with the contactless card; and
outputting the information stored in the contactless card to the contactless card reader, only in the case where the angle obtained in the obtaining is within a predetermined range.

20. A program for executing processing on information stored in a contactless card, the program causing a computer to execute:
detecting an angle of a flat antenna with respect to a horizontal plane, the antenna being for communicating with the contactless card; and
executing a predetermined operation, only in the case where the angle detected in the detecting is within a predetermined range.

21. A program for outputting information stored in a contactless card, the program causing a computer to execute:
obtaining an angle of a flat antenna with respect to a horizontal plane, from a contactless card reader that reads the information stored in the contactless card, the antenna being embedded in the contactless card reader for communicating with the contactless card; and
outputting the information stored in the contactless card to the contactless card reader, only in the case where the angle obtained in the obtaining is within a predetermined range.

22. A computer-readable storage medium in which a program for executing processing on information stored in a contactless card is stored,
wherein the program causes a computer to execute:
detecting an angle of a flat antenna with respect to a horizontal plane, the antenna being for communicating with the contactless card; and
executing a predetermined operation, only in the case where the angle detected in the detecting is within a predetermined range.

23. A computer-readable storage medium in which a program for outputting information stored in a contactless card is stored,
wherein the program causes a computer to execute:
obtaining an angle of a flat antenna with respect to a horizontal plane, from a contactless card reader that reads the information stored in the contactless card, the antenna being embedded in the contactless card reader for communicating with the contactless card; and
outputting the information stored in the contactless card to the contactless card reader, only in the case where the angle obtained in the obtaining is within a predetermined range.

24. An integrated circuit for executing processing on information stored in a contactless card, comprising:
a detecting unit operable to detect an angle of a flat antenna with respect to a horizontal plane, the antenna being for communicating with the contactless card; and
an executing unit operable to execute a predetermined operation only in the case where the angle detected by the detecting unit is within a predetermined range.

25. An integrated circuit for outputting information stored in a contactless card, comprising:
an obtaining unit operable to obtain an angle of a flat antenna with respect to a horizontal plane, from a contactless card reader that reads the information stored in the contactless card, the antenna being embedded in the contactless card reader for communicating with the contactless card; and
an output unit operable to output the information stored in the contactless card to the contactless card reader, only in the case where the angle obtained by the obtaining unit is within a predetermined range.
